(19) United States
(12) Patent Application Publication
(10) Pub. No.: US 2012/0077916 A1
(43) Pub. Date: Mar. 29, 2012

(54) Pressure Sensitive Adhesive Soluble in Acetone

(75) Inventors: José Maria Islas Manzur, Col. San Antonio (MX); Christopher J. Hardiman, Farmington, CT (US); Enrique Alejandro Rodríguez Resendiz, San Mateo Atenco (MX)

(73) Assignee: INDUSTRIAS NEGROMEX, S.A. DE C.V, Altamira (MX)

(21) Appl. No.: 13/247,784

(22) Filed: Sep. 28, 2011

Related U.S. Application Data
(60) Provisional application No. 61/387,095, filed on Sep. 28, 2010.

(51) Int. Cl. C09J 109/06; C08K 3/22; C08K 13/02; C08F 236/12

(52) U.S. Cl. 524/365; 526/318.6; 524/432

(57) ABSTRACT

An emulsion polymerization copolymer comprising 59-77 phr butadiene, 10-16 phr styrene; 10-16 phr acrylonitrile; and from 3-9 phr methacrylic acid is soluble in acetone for U.S. EPA-exempt, low-VOC emissions, while also soluble in toluene. The composition is formulated with a tackifying resin; a plasticizer oil; and a U.S. EPA-exempt solvent, preferably acetone, to make an adhesive. The formulation is particularly useful as a pressure sensitive adhesive for tape and for making shoes.

### CROSS-REFERENCE TO RELATED APPLICATION

Priority is claimed to U.S. Provisional Patent Application Ser. No. 61/387,095 filed by the inventors on Sep. 28, 2010, which is incorporated by reference.

### BACKGROUND OF THE INVENTION

1. Field of the Invention

The present invention pertains to adhesives, particularly to a pressure sensitive adhesive composition soluble in a solvent that is exempted by the U.S. Environmental Protection Agency (EPA) from regulation as a volatile organic compound, and more particularly to a pressure sensitive adhesive composition that is soluble in acetone.

2. Description of the Related Art

Pressure-sensitive adhesive compositions have a number of applications and are particularly useful in making an adhesive tape, which can be used for sealing packages, attaching one thing to another and as a masking tape in a painting application. U.S. Pat. No. 5,667,858, issued to Pokorny and incorporated by reference, describes a pressure-sensitive adhesive composition suitable for use in a masking tape that includes about 100 parts by weight of a crosslinkable elastomer, from 20 to 100 parts by weight of a tackifying resin, at least 0.1 part by weight of a higher aliphatic mercaptan, up to 30 parts by weight of a heat curable phenolic resin, and up to about 10 parts by weight of a catalyst for the phenolic resin. The '858 patent is typical of the prior art in this field in that “[t]he pressure sensitive adhesive compositions of the [Pokorny] invention are typically prepared by combining the individual components in a compatible organic solvent, i.e., an organic solvent in which the components can be uniformly dispersed, preferably dissolved, such as heptane, toluene, xylene, and the like. The composition is then mixed in a slow speed, high torque mixer until the components are uniformly dispersed, preferably dissolved. The resultant dispersion, preferably solution, can be applied to at least one surface of the backing by any one of several conventional techniques.” The '858 patent, column 9, lines 17-27. Organic solvents such as heptane, toluene and xylene have been determined by the U.S. EPA to be air pollutants and emissions have been regulated as volatile organic compounds (VOCs). Consequently, there is a need for a pressure sensitive adhesive composition that can be dissolved in a solvent that is not considered to be a pollutant, which the U.S. EPA has designated as solvents exempt from regulation under the rules and regulations for limiting emissions of VOCs.

### SUMMARY OF THE INVENTION

The present invention provides in one embodiment a composition containing elastomeric additives and other additives prepared in an EPA-exempted solvent, such as acetone, for use, for example, as an adhesive, preferably in an application such as in masking tape. Advantageously, the composition of the present invention provides adhesives that have adhesive strength equal to or better than adhesives that rely on hydrocarbon solvents such as heptane or toluene that are a source of volatile organic compounds (VOCs), the emission of which may be regulated by the U.S. EPA or other governmental agency.

The composition of the present invention in one embodiment includes compatible mixtures of a (a) copolymeric rubbery additive prepared from monomers selected from the group consisting of styrene, alpha methyl styrene, butadiene, isoprene, acrylonitrile, metacrylonitrile, ethylene, vinyl cetate, acrylic acid, esters of acrylic acid, methacrylic acid, esters of methacrylic acid and combination thereof; (b) tackifing resin; (c) plasticizer oil; (d) inorganic fillers and (e) one U.S. EPA-exempt solvent, such as acetone. As used herein, compatible means that each component of the composition is sufficiently dispersed in, preferably sufficiently soluble in, the other components such that each component remains in dispersion without substantial separation or precipitation (without bloom).

The present invention provides in one embodiment a polymer composition made by emulsion polymerization of from 59 to 77 phr butadiene monomer, from 10 to 16 phr styrene monomer; from 10 to 16 phr acrylonitrile monomer; and from 3 to 9 phr methacrylic acid monomer. The adhesive composition of the present invention, in one embodiment that can be used as pressure sensitive adhesives, includes about 100 parts by weight of a rubbery copolymer, at least about 130 parts by weight of a tackifying resin, about 40 parts by weight of plasticizer oil, about 3 parts by weight of zinc oxide and at least about 200 parts by weight of an U.S. EPA-exempt solvent, preferably acetone.

The present invention provides in one embodiment a random copolymer formed by emulsion polymerization of about 68 phr butadiene monomer, about 13 phr styrene monomer, about 13 phr acrylonitrile monomer and about 6 phr methacrylic acid monomer, which is preferably formulated with at least about 130 parts by weight of a tackifying resin; at least about 47 parts by weight of a plasticizer oil; at least about 3 parts by weight of sulfur; at least about 3 parts by weight of zinc oxide: at least about 6 parts by weight of ant oxidative agent; and at least about 300 parts by weight of a U.S. EPA-exempt solvent, which is preferably acetone.

Another embodiment of the invention is a process for making a copolymer. The process includes the steps of: (1) feeding butadiene, styrene, acrylonitrile and methacrylic acid monomers to a reactor; (2) adding a free radical initiator to the reactor; (3) copolymerizing the butadiene, styrene, acrylonitrile and methacrylic acid monomers until a conversion of from about 75% to about 95% is reached; and (4) recovering a butadiene-styrene-acrylonitrile-methacrylic acid copolymer having a composition of from 59 to 77 phr butadiene, from 10 to 16 phr styrene, from 10 to 16 phr acrylonitrile, and from 3 to 9 phr methacrylic acid. Preferably, the copolymer composition is soluble in acetone to the extent of having a gel content in acetone of less than about 10 wt %. The polymer composition is further preferably soluble in toluene to the extent of having a gel content in toluene of less than about 50 wt %.

The present invention provides in one embodiment an adhesive tape made with a pressure sensitive adhesive composition that is soluble in an U.S. EPA-exempt solvent, preferably acetone. The adhesive tape preferably has a backing with a pressure sensitive adhesive composition of the present invention coated on at least a portion of at least one surface, although the tape may also be provided in the form of an adhesive transfer tape. Also included within the scope of the present invention are a substrate having an adhesive tape thereon and a method for preparing a pressure sensitive adhesive product.

### DETAILED DESCRIPTION OF THE EXEMPLARY EMBODIMENTS

One of the key components of the present invention is a novel copolymer composition comprising a random blend of monomers selected from the group comprising styrene, alpha metyl styrene, butadiene, isoprene, acrylonitrile, metacrylonitrile, ethylene, vinyl acetate, acrylic acid, esters of acrylic acid, methacrylic acid, esters of methacrylic acid and combination thereof. The ratio of the blend of monomers provides solubility in or is compatible with a U.S. EPA-exempted solvent, preferably acetone. In the context of the present invention, the terms polymeric or polymer is used herein in its most general sense to mean a compound consisting essentially of repeating structural units. Also in the same context the terms copolymeric or copolymer mean a polymer consisting of four repeating structural units selected from group: styrene, alpha methyl styrene, butadiene, isoprene, acrylonitrile, metacrylonitrile, ethylene, vinyl acetate, acrylic acid, esters of acrylic acid, methacrylic acid, esters of methacrylic acid and combination thereof.

It was discovered, surprisingly, that a copolymer formulated with: (a) butadiene from 30 to 80 parts per hundred rubber (phr), and preferably from 40 to 75 and more preferably range from 50 to 70; (b) styrene from 5 to 30 and preferably from 5 to 25 and more preferably range from 10 to 20; (c) acrylonitrile from 5 to 30 and preferably from 5 to 25 and more preferably range from 10 to 20; and (d) methacrylic acid from 1 to 20 and preferably from 2 to 15 and more preferably range from 3 to 12 phr, is soluble in acetone, while also soluble in traditional U.S. EPA-non-exempt solvents such as toluene.

The method to prepare this novel copolymer is advantageously prepared in a pressure vessel by polymerization of the particular monomers in an aqueous medium under the known conditions of emulsion polymerization in the presence of water-soluble free radical initiators and emulsifiers and the presence or absence of molecular weight regulators, buffer substances and further assistants to conversions of not less than about 80%. A preferred process for preparing this polymer is a batch emulsion polymerization process in which water, all the monomers, initiators, emulsifiers, molecular weight regulators, buffers, and further assistants are added to a stirred, pressurized vessel at the beginning of the procedure. The polymerization temperature is from 30 to 70° C., preferably from 45 to 65° C. Generally, the overall reaction is allowed to proceed to a conversion of the monomers in the range of about 75 to about 95%.

The emulsion polymerization process can be conducted using various emulsifiers selected from the group linear sodium dodecyl benzene sulphonate, sodium dodecyl sulfate, sodium cyclohexyl sulfosuccinate or phosphates-types emulsifiers. Various antioxidants are generally added such as the phosphites-types, phenol-types, amine-types and a combination thereof. Molecular weight regulators are added to control copolymer chain length such as tertiary mercaptans containing about 8 to 16 carbons, particularly mixtures of such mercaptans. Representative of such regulators are tertiary nonyl and dodecyl mercaptan. The copolymerization can be catalyzed by various free radical catalysts such as organic hydroperoxides, inorganic peroxides and the azoisobutylonitrile-type. Representative of various organic hydroperoxides are cumene hydroperoxide, isopropyl benzene hydroperoxide and para methane hydroperoxide. Representative of various inorganic hydroperoxides are hydrogen peroxide, as well as ammonium, sodium and potassium persulfate.

When it is believed that the polymerization should be stopped, a strong inhibitor selected from the group hydroquinone, tert-butyl hydroquinone, tert-amyl hydroquinone, methyl hydroquinone can be added, which causes all of polymerization activity to cease. After terminating the polymerization, a resultant conjugated diene-based rubber latex is made free from unreacted monomers, if necessary, by means of steam distillation or the like, and then coagulated with a salt such as sodium chloride, potassium chloride, calcium chloride, magnesium sulphate or with hydrochloric acid, nitric acid or sulphuric acid or as a salt-acid combination to aggregate the conjugated diene-base rubber as crumb. The coagulating agent can be selected from among one or more of aluminum chloride, calcium chloride, iron chloride, magnesium chloride, potassium chloride, sodium chloride, cobalt nitrate, aluminum sulfate, iron sulfate, magnesium sulfate, nickel sulfate, zinc sulfate, hydrochloric acid, nitiric acid, sulfuric acid, or salt-acid combination such as a solution of sodium chloride in a sulfuric acid solution. The crumb is washed, dehydrated and then dried with a drier or the like, yielding a rubber composition that includes butadiene, styrene, acrylonitrile and methacrylic acid.

A butadiene/styrene/acrylonitrile/methacrylic acid rubber synthesized according to this invention has outstanding characteristics for use in making a pressure-sensitive adhesive because the rubber is soluble in acetone and has excellent adhesive properties when mixed with tackifiers and other additives normally used for this purpose. This is by virtue of the balance discovered for the composition of the repeating units of butadiene, styrene, acrylonitrile and methacrylic acid. The inventive rubber has a very low gel content (insoluble material) not only in traditional solvents such as toluene or methyl ethyl ketone, but also in acetone, a U.S EPA-exempted solvent. Other important characteristics of our inventive rubber that control its outstanding performance as a component of the composition of a pressure-sensitive adhesive composition are its glass transition temperature, its molecular weight and its Mooney viscosity. The glass transition temperature of the polymer is determined by the types of monomers and their levels contained as residues in the polymer. A suitable range for this property of the polymer includes values in the range of from −40° C. to 0° C., preferably in the range of from −35° C. to −5° C., and more preferably in the range of from −30° C. to −10° C. The glass transition temperature is determined by differential scanning calorimetry in accordance with ASTM D3418-88.

The weight-average molecular weight of the rubber copolymer represented as polystyrene determined by gel permeation chromatography (GPC) is preferably 100,000 or more, more preferably 100,000 to 2,000,000. A weight-average molecular weight less than 100,000 may lead to a reduced structural resistance of the adhesive. On the other hand, a molecular weight exceeding 2,000,000 may lead to poor solubility in the pressure-sensitive adhesive formulation. Mooney viscosity is an important parameter because it is closely related with the molecular weight of the rubbers. For this invention the preferred range of the Mooney viscosity [ML1+4 (100° C.)] is from 20 to 200 and more preferably from 25 to 150.

The pressure-sensitive adhesives of the present invention have sufficient tack to adhere to substrates using only light finger pressure. Additionally, they have sufficient adhesive strength to resist lifting from a substrate after being applied. Preferred pressure-sensitive adhesives of the present invention are removable with little or no adhesive transfer. That is, preferred pressure-sensitive adhesives of the present invention leave little, if any, adhesive on the surface of a substrate after removal of an adhesive-backed tape. This is particularly advantageous in applications that require application of heat. Thus, the pressure-sensitive adhesive composition of the present invention provides products that result in only slight, if any, adhesive transfer and preferably no adhesive transfer, upon removal. As used herein, slight adhesive transfer means that no more than about 10% of a surface covered by the adhesive retains any visible residue of adhesive upon removal of the tape. As used herein, heavy adhesive transfer means that more than about 10% of the surface covered by the adhesive retains visible residue of the adhesive after removal of the adhesive-backed tape.

A composition of this invention comprising a butadiene/styrene/acrylonitrile/methacrylic acid copolymer and a tackifier resin that is generally suitable as an adhesive can be conveniently prepared by mixing the butadiene/styrene/acrylonitrile/methacrylic acid copolymer with the suitable tackifying resin in the presence of a volatile organic solvent. The mixing is usually accomplished at a temperature at the range 0° C. to about 50° C. and more typically from about 20° C. to 40° C. Various aliphatic or aromatic hydrocarbons and oxygenates can be used for this purpose. Representative of the various aliphatic hydrocarbons are pentane, hexane, heptane, cyclohexane and octane, and representative of various aromatic hydrocarbons are toluene, benzene, and xylene. Emissions of these aliphatic and aromatic solvents are limited in the U.S. by EPA rules. However, emissions of some oxygenated solvents, including acetone and butyl acetate, are permitted and are exempt from VOC emission restrictions under U.S. EPA rules and regulations. The problem with these oxygenated solvents is their lack of compatibility with typical styrene-butadiene rubber.

Surprisingly, the copolymer that we invented formulated with: (a) butadiene from 30 to 70, and preferably from 40 to 70 and more preferably range from 50 to 70; (b) styrene from 5 to 30 and preferably from 5 to 25 and more preferably range from 10 to 20; (c) acrylonitrile from 5 to 30 and preferably from 5 to 25 and more preferably range from 10 to 20; and (d) methacrylic acid from 1 to 20 and preferably from 2 to 15 and more preferably range from 3 to 12, showed solubility not only in the traditional aliphatic and aromatic solvents, but also in the oxygenated solvents, particularly acetone, which is one of the solvents that is exempt from U.S. EPA VOC emission restrictions.

In general, the amount of the rubber that is used in a pressure-sensitive adhesive composition is effective to produce desirable cohesion and elastic qualities in the adhesive product of the present invention. Furthermore, the amount of the tackifying resin that is used is effective to provide desirable tack or adhesive quality to the adhesive.

The pressure-sensitive adhesive composition of the present invention preferably contains about 100 parts by weight of the rubber of the present invention, about 20 to 160 parts by weight tackifying resin, from about 10 to 60 parts by weight of plasticizer oil, and about 1 to 10 parts of crosslinker additives such as sulfur, zinc oxide or ethyl zimates. These parts are based on the amount of the rubber. More preferably, the composition of the present invention contains about 100 parts of rubber, about 30 to 140 parts by weight tackifying resin, from about 15 to 55 parts by weight of plasticizer oil, and about 2 to 9 parts of crosslinker additives such as sulfur, zinc oxide or ethyl zimates.

Tack is the term used to quantify the sticky or adhesive characteristics of an adhesive composition. The tackifier or the tackifying resin contributes to the tack, shear strength, and peel strength of the adhesive. The tackifier used in the pressure-sensitive adhesive composition of the present invention can be any tackifier, or mixture of tackifiers, typically used in pressure-sensitive adhesives. It can be a solid or liquid tackifier. Suitable tackifiers are those that are amorphous, noncrystalline materials that are compatible with the rubber. Preferably, the tackifiers are soluble in the solvent used in the composition of the present invention. Tackifiers are well known in the art. Suitable tackifiers include, but are not limited to, aliphatic hydrocarbon resins, aromatic hydrocarbon resins, coumarone-indene resins, terpene phenol resins, rosin acid derivatives such as rosin esters, and the like. The choice of tackifying resin or resins depends on the rubber or mixture of rubbers in the composition. For example, acrylonitrile-butadiene base rubbers are typically tackified by tackifying resins composed of terpene phenol resins sold under the trade name Sylvares TP 96 by Arizona Chemical Co.

In the preparation of a butadiene-styrene-acrylonitrile-methacrylic acid and tackifying resin adhesive composition of this invention, it is understood that minor amounts of various antioxidants, oils, inorganic pigments, curing agents and fillers can be added and mixed therewith to enhance its aging characteristics and physical properties.

A pressure-sensitive adhesive composition of the present invention may include plasticizer oils. Suitable plasticizer oils include, but are not limited to, petroleum aromatic oils, petroleum naphthalene oils, oils from phthalic anhydride such as dioctyl phthalate, dibuyl phthalate, nonyl phthalate and combinations thereof. Preferably, the plasticizer oil used in the composition of the present invention are those derived from phthalic anhydride such as dioctyl phthalate, dibuyl phthalate, nonyl phthalate and combinations thereof and more preferably dioctyl phthalate. A suitable plasticizer oil based in octyl phthalate is sold under the trade name DOP by Charlotte Chemical, Inc., which is believed to be located in Houston, Tex. In general, if a plasticizer oil is used, then enough plasticizer oil should be used to achieve a desired result. If desired, typically up to about 40 phr, preferably up to about 45 phr, and more preferably up to about 50 phr can be used in the pressure-sensitive adhesive composition, excluding solvent.

Inorganic fillers may be used in the pressure-sensitive adhesion composition, including silica, aluminum oxide, zinc oxide, clay, calcium carbonate, magnesium carbonate and the like. Zinc oxide is preferred and is not particularly limited. A zinc oxide generally used as a reinforcing agent for a synthetic rubber would be suitable. If an inorganic filler such as a zinc oxide is employed, it may preferably be present in an amount of 1 to 10 parts, particularly 1 to 7 parts based on 100 parts of a total rubber component. An amount of the inorganic filler of less than 1 part leads to an insufficient reinforcing effect, resulting in a poor structural resistance of the pressure-sensitive adhesive composition. A sufficient reinforcing effect can be accomplished when the filler amounts to 3 to 5 parts, and no further amount should be required.

Curing agents can be used in the adhesive composition of the present invention to increase the strength of the pressure-sensitive adhesion composition. Suitable curing agents include, but are not limited to, sulfur, ethyl and buthyl zimates and thio substances. Preferably, the curing agents used in the composition of the present invention are sulfur and ethyl zimates, which can be purchased from Ciba-Geigy Corp. In general, if a curing agent is used, then enough curing agent should be used to achieve a desired result. If desired, typically at least about 1 phr, preferably about 1 to 5 phr, and more preferably about 1 to 3 phr, can be used in the pressure-sensitive adhesive composition, excluding solvent.

Antioxidants can be used in the adhesive composition of the present invention to reduce the degradation of the rubber upon exposure to high temperature. Suitable antioxidants include, but are not limited to, hindered phenolics, thioesters, phosphites, and hindered amines. Preferably, the antioxidants used in the composition of the present invention are hindered phenolics. Specific examples of suitable antioxidants include hindered phenolics sold under the trade names Alkanox P-24™ by Chemtura. In general, if an antioxidant is used, then enough antioxidant should be used to achieve a desired result. If desired, typically at least about 2 phr, preferably from about 2 to 8 phr, and more preferably from about 2 to 6 phr, can be used in the pressure-sensitive adhesive composition, excluding solvent.

The composition of this invention has particularly utility as a pressure-sensitive adhesive. For example, pressure-sensitive tape can conveniently be prepared by applying a mixture comprised of a solution of the adhesive composition to a flexible substrate and drying the mixture. For this purpose, generally a thickness of the composition on the flexible substrate in the range of about 0.5 to about 2 mils is satisfactory.

The present invention includes within its scope a pressure sensitive adhesive and also the preparation of pressure-sensitive adhesive products such as tape. An adhesive tape typically has a backing with a pressure sensitive adhesive composition coated on at least a portion of at least one surface, although the tape may also be provided in the form of an adhesive transfer tape. A variety of backing materials are suitable for use in pressure-sensitive adhesive products, such as tapes. The backing is generally thin and flexible so that the adhesive-coated tape can be wound upon itself in roll form and can conform to surfaces to which the tape is applied. For a masking tape, preferably the backing is about 0.01 to 0.10 inch (0.026-0.265 cm) thick, and more preferable about 0.01-0.07 inch (0.026-0.179 cm) thick so that a very thin paint line is produced in masking applications. Tape can be non-fibrous, fibrous, or a combination thereof. For example, polymeric films, fabrics, glass, asbestos, paper, and metallic films can be used. Fabrics can be made of synthetic material or natural fibers. Examples of fabrics include, but are not limited to, polyamides such as nylon, polyesters such as dacron, cotton, linen, and rayon. Paper is generally made of a high proportion of softwood fibers for optimum strength and mechanical characteristics. Examples of suitable papers for this purpose are glassine, parchment, supercalendered, kraft, clay coated kraft, machine glazeda, soft-nip and machine-calender kraft. Examples of suitable metallic films include, but are limited to, aluminum, copper, lead, iron, and zinc foils. Typically, the backing material is chosen such that it is generally resistant to organic solvents and high temperatures and is not deleteriously affected by solvents and temperatures used in painting operations.

Other suitable backing materials include, but are not limited to, ethyl cellulose, regenerated cellulose, cellulose acetate, cellulose acetate-butyrate, acrylonitrile polymers, plasticized and unplasticized vinyl chloride polymers such as polyvinyl chloride, polyvinylidene chloride-vinyl chloride polymers, polyethylene, polypropylene; polytetraflouoethylene, polyvinyl alcohol, polymers of styrene such as styrene and acrylonitrile, and polyesters such as Mylar®. Preferred backing materials include plasticized vinyl and paper. Paper backing tears easily and withstands higher temperature than many plastics.

The pressure-sensitive adhesive compositions of the present invention are typically prepared by combining the individual components in a compatible organic solvent, in which the components can be uniformly dispersed, preferably dissolved, such as heptane, toluene, xylene, acetone and the like. Preferably, the solvent used in the composition of the present invention is acetone, which is a U.S. EPA exempted solvent. The composition is then mixed in a slow speed, high torque mixer until the components are uniformly dispersed, preferably dissolved. The resultant dispersion, preferably a solution, can be applied to at least one surface of a backing material by any one of several techniques, including for example, direct and reverse roll, rubber roll and knife, or knife and rubber blanket. The amount of solvent used can vary depending upon the desired composition viscosity, coating thickness, coating apparatus, and backing material. In general, a composition of about 20-70% solvent by weight has a satisfactory viscosity for use with most coating machines and upon most backings. The adhesive composition is generally coated in an amount of about 15-75 g/m² of the surface of the backing.

The coated backing material may be subjected to a drying step to remove the solvent. Typically, this involves exposing the coated backing material to a temperatures of less than about 212° F. (100° C.), preferably about 150-200° F. (65-93° C.). When exposed to such temperatures, the solvent is typically removed by evaporation in less than about 5 minutes, preferably about 1-3 minutes. Generally, the higher the temperatures used for drying, the shorter the exposure time required.

In order to increase the strength of the pressure-sensitive adhesive composition, a small amount of curing should occur between the rubber and a terpene phenolic resin, which is helped by the curing additives sulfur and ethyl zimate. To do that, pressure-sensitive adhesive tape of the present invention is preferably subjected to a curing step. This involves exposing the coated backing material to a temperature of less than about 300° F. (149° C.), preferably about 248-284° F. (120-140° C.). When exposed to such temperatures, the pressure-sensitive-adhesive composition over the tape is partially cured, enough to increase its strength, in less than about 5 minutes, preferably about 2-4 minutes. Generally, the higher the temperature used for curing, the shorter the exposure time required.

As a result, the adhesive composition of the present invention, which employs the terpene phenolic resin and curing agents, can be applied to a backing material and stored or used immediately without further processing. The resultant product can be used effectively in applications requiring any of a variety of temperatures, including room temperature. If the adhesive composition is used in an application that requires the use of high temperatures, the adhesive cures in upper grade upon exposure to the elevated temperatures. Advantageously, the cured adhesive leaves little or no adhesive residue upon removal from the surface to which it was applied, which provides a significant advantage.

Although the pressure-sensitive adhesive compositions of the present invention can be used in various applications, the compositions are particularly useful in masking tape for painting applications and as a glue for adhering parts of a shoe together. In many industries, such as the automobile and appliance industries, it is desirable to spray paint finished products so that they will be in one color or tone on one side of some predetermined demarcation zone, such as a line, and of another color or tone on the side of the demarcation zone. Such demarcation must be substantially precise along the demarcation zone so as to maintain consistency of finish. Typically, the masking tape is affixed to a surface of a workpiece with one tape side edge disposed coexistent with the demarcation zone. This separates that portion of the workpiece surface that is to be painted from that portion that is not to be painted. The tape can be used alone or to retain paper, cloth, or a plastic film adjacent to the demarcation zone and in a position to cover a portion of a workpiece that is to be protected during application of the paint. In the shoe application, the inventive adhesive composition is particularly useful for bonding a sole of a shoe to an upper portion of the shoe.

### EXAMPLES

The following examples are used to further illustrate the various specific and preferred embodiments and techniques. It should be understood, however, that many variations and modifications may be made while remaining within the scope of the present invention.

### Examples 1a and 1b

In a polymerization vessel fitted with a stirrer, 125 parts of water, 5 parts of seed latex, 2.5 parts of sodium dodecyl benzensulphonate, 0.15 parts of sodium polynaphthalene sulphonate, 0.1 parts of sodium pyrophosphate, 68 parts of butadiene, 13 parts of styrene, 13 parts of acrylonitrile, 6 parts of methacrylic acid and 0.6 parts of tert-dodecyl mercaptan were charged. Subsequently, the temperature of the polymerization vessel was set at 50° C. and 0.1 parts of potassium persulphate as a radical initiator was added to the polymerization vessel, thereby initiating the polymerization reaction. Once the conversion of the polymerization reached 80% for Example 1a and 90% for Example 1b, 0.3 parts of diteramyl hydroquinone was added to shortstop the polymerization. Subsequently, any unreacted monomer was recovered by steam stripping, and a conjugated diene-based rubber latex was obtained. The rubber was recovered from the latex by adding a 10% solution of calcium chloride until all the rubber was coagulated. The recovered rubber coagulum was washed with deionized water and dried. The rubber obtained was determined to have a bound styrene content of 13%, a bound acrylonitrile content of 13%, a bound methacrylic acid content of 6%, and a bound butadiene content of 68%, with a Tg of −13° C., a Mooney viscosity of 40 and was completely soluble in acetone and toluene, meaning no gel was present when dissolved in either acetone or in toluene. A summary of the polymerization formulation is given in Table 1.

TABLE 1
Polymerization Formulation for
Examples 1a and 1b.

| Component | phr |
|---|---|
| Butadiene | 68.0 |
| Styrene | 13.0 |
| Acrylonitrile | 13.0 |
| Methacrylic acid | 6.0 |
| Tert-dodecyl mercaptan | 0.6 |
| Sodium dodecyl benzene | 2.5 |
| sulphate | |
| Sodium polynaphthalene | 0.15 |
| sulphonate | |
| Sodium pyrophosphate | 0.1 |
| Potassium persulphate | 0.1 |

### Examples 2-11

In examples 2-11 copolymers were produced by the same technique as in the preparation of Example 1 above, except that the amounts or ratios of the monomers were changed as presented in Table 2. The main characteristics of the rubber products obtained in polymerization examples 1 to 11 are presented in Table 3.

TABLE 2
Monomer Ratios for Examples 1 to 11.

| | Examples | | | | | | | | | | |
|---|---|---|---|---|---|---|---|---|---|---|---|
| | 1 | 2 | 3 | 4 | 5 | 6 | 7 | 8 | 9 | 10 | 11 |
| Butadiene | 68 | 71 | 71 | 77 | 71 | 59 | 74 | 62 | 62 | 62 | 65 |
| Styrene | 13 | 13 | 13 | 10 | 10 | 16 | 10 | 16 | 16 | 13 | 13 |
| Acrylonitrile | 13 | 13 | 10 | 10 | 13 | 16 | 13 | 16 | 13 | 16 | 16 |
| Methacrylic | 6 | 3 | 6 | 3 | 6 | 9 | 3 | 6 | 9 | 9 | 6 |
| acid | | | | | | | | | | | |

TABLE 3
Main characteristics of the Rubber Products Obtained in Polymerization Examples 1 to 11.

| | | | | | | | Gel content | | |
|---|---|---|---|---|---|---|---|---|---|
| | | | Mooney | | | | in | Gel content | Mol. |
| Ex. | Conv., % | Tg, ° C. | Viscosity | G′ | G″ | Tan D | acetone, % | in Toluene, % | weight, Mw |
| 1a | 80 | −32.0 | 16.0 | 11.6 | 9.97 | 0.86 | <1 | <1 | 181 046 |
| 1b | 90 | −34.1 | 35.7 | 35.8 | 21.46 | 0.60 | 67 | 30 | 95 069 |
| 2a | 80 | −42.8 | 22.5 | 21.9 | 15.65 | 0.71 | 7 | <1 | 162 752 |
| 2b | 90 | −42.5 | 25.5 | 26.9 | 16.48 | 0.61 | 23 | <1 | 99 556 |
| 3a | 80 | −41.8 | 39.4 | 38.1 | 22.89 | 0.60 | 38 | <1 | 90780 |
| 3b | 90 | −44.0 | 47.2 | 53.39 | 24.65 | 0.46 | 57 | 19 | 122 690 |
| 4a | 80 | −54.3 | 37.0 | 37.68 | 19.30 | 0.51 | 60 | <1 | 207 017 |
| 4b | 90 | −55.2 | 39.7 | 47.83 | 22.33 | 0.47 | 73 | 19 | 160 428 |
| 5a | 80 | −43.0 | 27.2 | 24.19 | 17.04 | 0.70 | <1 | <1 | 167 763 |
| 5b | 90 | −44.0 | 34.0 | 39.50 | 21.6 | 0.56 | <1 | <1 | 156 518 |
| 6a | 80 | −20.7 | 16.4 | 16.94 | 16.11 | 0.85 | <1 | 58 | 146 716 |
| 6b | 90 | −17.3 | 33.5 | 46.10 | 32.75 | 0.71 | <1 | 69 | 134 648 |
| 7a | 80 | −46.4 | 32.8 | 31.2 | 18.85 | 0.61 | 36 | <1 | 190 767 |
| 7b | 90 | −48.6 | 42.5 | 40.84 | 22.17 | 0.54 | 86 | 23 | 204 906 |
| 8a | 80 | −23.2 | 16.5 | 14.03 | 13.32 | 0.95 | <1 | <1 | 136 206 |
| 8b | 90 | −23.4 | 26.3 | 27.03 | 20.23 | 0.75 | <1 | 16 | 140 963 |
| 9a | 80 | −25.6 | 17.9 | 15.30 | 15.25 | 0.99 | <1 | 39. | 128 087 |
| 9b | 90 | −25.7 | 39.5 | 39.33 | 28.59 | 0.73 | <1 | 54 | 111 851 |
| 10a | 80 | −19.3 | 24.0 | 26.82 | 22.57 | 0.84 | <1 | 72 | 118 890 |
| 10b | 90 | −22.1 | 37.7 | 30.65 | 20.58 | 0.67 | 7 | 87 | 174 043 |
| 11a | 80 | −29.5 | 18.5 | 15.81 | 13.74 | 0.87 | <1 | <1 | 141 173 |
| 11b | 90 | −29.1 | 27.6 | 30.84 | 21.79 | 0.71 | 6 | 26 | 157 257 |

Example 1 was the base composition for the experiments. Examples 2 to 4 have lesser amounts of polar monomers than example 1, and they are less soluble in acetone, which is polar, and more soluble in toluene, which is non polar. Examples 5 to 11, with the exception of example 7, have higher amounts of polar monomers, and they are almost fully soluble in acetone but are less soluble in toluene. Example 7 has a lower amount of methacrylic acid than example 1 and is less soluble in acetone than example 1. Several compositions are designed for only partial solubility in one particular solvent because insoluble fraction (gel) provides a skeleton for the adhesive, and the soluble fraction permits easy diffusion into pores, in which case complete solubility in acetone is not essential for good performance in an adhesive formulation. A proper balance between the gel and the soluble fractions is desired for good adhesive performance. It was discovered that methacrylic acid monomer provides good adhesive properties. Examples 28 and 31 below (from the rubber compositions in examples 6 and 9) have higher amounts of methacrylic acid and have good adhesive performance in peel strength and shear, while in contrast, example 24 (using the rubber composition in example 2) has a lesser amount of MAA and has adhesive performance properties that are not as good.

### Examples 12-33

### Pressure-Sensitive Adhesive Composite and Tape Preparation

For examples 12 to 33 of this invention, pressure-sensitive adhesive (PSA) composites of examples 1-11, where example a indicates 80% conversion and example b indicates 90% conversion, were prepared using the formulation shown in Table 4. Each of the examples was prepared by dissolving the components described in Table 4 using a high shear agitator, first starting to dissolve the rubber in acetone and then pouring in subsequently other components until complete dissolution of all components was obtained. A preparation flask was weighed before and after the dissolution of the components in order to replace losses of acetone. Sylvares TP-96 is a low softening point terpene phenol resin sold by Arizona Chemical Co. for improving the tack, peel and flexibility of pressure sensitive adhesives. Alkanox P-24 is an antioxidant sold by Great Lakes Chemical Corp.

TABLE 4
Formulation of PSA Composites for
Examples 12 to 33.

| Raw Material | phr |
|---|---|
| Rubber from Examples 1 to 11 | 100 |
| Resin Sylvares TP-96 | 132 |
| Sulfur | 3 |
| Dioctyl phthalate, | 47 |
| Zinc oxide | 3 |
| Alkanox P-24 | 6 |
| Acetone | 300 |

Pressure-sensitive adhesive composites prepared under the formulation in Table 4 were used to prepare tapes. The acetone cement solutions were used for coating styrene-butadiene rubber saturated crepe paper approximately 0.008 inches (0.03 cm) thick. The solvent from the adhesive composition was removed by drying the adhesive-coated tape for 5 minutes at room temperature and then at 150° F. (66° C.) in an air circulating oven for 2 minutes. Curing was done thermally in an oven at 130° C. by 3 minutes. The resulting tape was cut into 1×7 inch (2.54×17.78 cm) pieces in order to be used for measuring the results of an adhesion test. Samples of tape prepared from the composites of the present invention were tested for adhesive residue remaining after removal of tape and for the adhesive properties of peel, shear and tack.

For an inverted test, the tape prepared from the composition of the present invention was tested for adhesive residue remaining after removal of the tape. Pieces of the tape were applied to a polished steel panel. Pressure was then applied to the tape samples with two double passes of a 4.5 pound (2.041 kg) roll down, and the sample was placed for 15 minutes in an air circulating oven at 130° C. in an inverted position. A 25 g weight was attached to one end of the tape for peeling the tape off the polished steel panel. The time that the tape remained adhered to the panel was measured and the amount of adhesive residue remaining on the steel panel after the tape peeled off was evaluated as being none, slight, or heavy, with slight being less than about 10% of the surface covered with visible residue of the adhesive and heavy being about 10% or more of the surface covered with visible residue of the adhesive, after the tape was peeled off by the weight.

Peel strength was measured using an Adhesion/Release Tester AR-1000 made by ChemInstruments, Inc. following the Pressure Sensitive Tape Council (“PSTC”) method 1. One-inch wide test strips were prepared and applied to stainless steel panels using roll down equipment for two double passes. The test strips were allowed to dwell for 24 hours before testing peel at an angle of 90° at a rate of 12 inches per minute using a tensile tester. Peel strength was measured as gf.

Tack was measured using the Loop Tack tester equipment by ChemInstruments, Inc. in accordance with ASTM D 6195-03 for “Standard Test Methods for Loop Tack.” Pieces of the tape measuring 1×4 inch (1.27×cm) were cut and a loop was formed and attached to a mobile arm of the equipment, which measured the force required to remove the tape, in gf.

Shear was measured using a Bank Oven Shear HT tester made by ChemInstruments in accordance with ASTM D 6463-99 standard method “Time to Failure of Pressure Sensitive Articles Under Sustained Shear Loading.” One end of an adhesive strip made according to the method set forth above was applied to a stainless steel panel so that the strip contacted a 1 inch by 1 inch portion of one side of the panel. The strip was trimmed so that only a 2 inch portion hung over an edge of the panel. The panel was hung in a vertical position with a 0.5 kilogram weight suspended from the overhanging portion of adhesive strip. The time required for the strip to peel off the panel was measured.

### Example 34

### Adhesive Tape Made Using Commercial Rubbers

Comparative examples 34 and 35 were prepared according to the procedure for examples 12 to 33, except that the base polymer was a typical rubber that is available commercially and used in adhesive compositions. Also, solvent, tackifying resins and plasticizers were changed according to the compatibility of the commercial rubber. Composition of the formulation using commercial rubber is presented in Table 5. Pressure-sensitive adhesive composites of the comparative examples 34 and 35 were used to prepare and evaluate tape using the procedure outlined in Examples 12 to 33.

TABLE 5
Formulation of Comparative Pressure-Sensitive
Adhesive Compositions.

| Example | 34 |
|---|---|
| Rubber | Solprene |
| | 411 |
| phr rubber | 100 |
| phr of Piccotac tackifier 113^{a} | 40 |
| phr of Pentalyn 345^{b} | 30 |
| phr Dioctyl phthalate, | 15 |
| phr Zinc oxide | 5 |
| phr toluene | 150 |

^{a}Sold by Eastman Chemical Company
^{b}An ester-based resin sold by Eastman Chemical Co.

### Example 35

### Commercial Masking Tape

Comparative example 35 consists of a commercially-available masking tape sold by 3M Corporation under the trademark 3M Specialty Tape, which is generally recognized as a very good masking tape.

Results

The results of the inverted, peel strength, tack, and shear resistance tests for examples 12 through 35 are set forth in Table 6.

TABLE 6
Adhesive performance results.

| | Examples | | | | | | | | | | |
|---|---|---|---|---|---|---|---|---|---|---|---|
| | 12 | 13 | 14 | 15 | 16 | 17 | 18 | 19 | 20 | 21 | 22 |
| Rubber from | 1a | 2a | 3a | 4a | 5a | 6a | 7a | 8a | 9a | 10a | 11a |
| example No. | | | | | | | | | | | |
| Inverted test: | | | | | | | | | | | |
| Adhesive | heavy | heavy | slight | heavy | slight | heavy | slight | heavy | heavy | slight | heavy |
| transfer | | | | | | | | | | | |
| Time to peel | 77 | 154 | >180 | 12 | >180 | 35 | 52 | 47 | 13 | 54 | 44 |
| off | | | | | | | | | | | |
| Peel | 707 | 1628 | 1574 | 765 | 2236 | 1996 | 1309 | 1671 | 533 | 908 | 659 |
| Strength | | | | | | | | | | | |
| Tack | 735 | 485 | 1245 | 925 | 1100 | 780 | 1630 | 560 | 160 | 345 | 375 |
| Shear | 536 | 93.6 | 400 | 16 | 104 | 453 | 90 | 262 | 70 | 2782 | 640 |
| | Examples | | | | | | | | | | |
| | 23 | 24 | 25 | 26 | 27 | 28 | 29 | 30 | 31 | 32 | 33 |
| Rubber from | 1b | 2b | 3b | 4b | 5b | 6b | 7b | 8b | 9b | 10b | 11b |
| example No. | | | | | | | | | | | |
| Inverted test: | | | | | | | | | | | |
| Adhesive | heavy | heavy | heavy | heavy | heavy | None | heavy | heavy | none | none | none |
| transfer | | | | | | | | | | | |
| Time to peel | 115 | 69 | >180 | >60 | >60 | 58 | >180 | 22 | >120 | 46 | 10 |
| off | | | | | | | | | | | |
| Peel Strength | 1224 | 1538 | 1108 | 1870 | 694 | 2009 | 1560 | 680 | 2098 | 1163 | 2635 |
| Tack | 630 | 890 | 1110 | 1870 | 1305 | 1420 | 1770 | 50 | 847 | 1160 | 495 |
| Shear | 1145 | 90 | 1416 | 163 | 221 | 1766 | 1573 | 477 | 1639 | 1159 | 109 |

Comparative examples

| | 34 | 35 |
|---|---|---|
| Rubber from example No. | Solprene 411 | 3M Specialty Tape |
| Inverted test: | | |
| Adhesive transfer | heavy | heavy |
| Time to peel off | >60 | >60 |
| Peel Strength | 1500 | 787 |
| Tack | 705 | 940 |
| Shear | 2500 | 1654 |

Comparative examples 34, which use commercially-available rubber and 35 which is a commercial masking tape are believed to provide satisfactory adhesive performance results. Inventive formulations that have adhesive performance results comparable to the results for comparative examples 34 and 35 should thus be satisfactory. All of the inventive formulations for which data is available appear to have satisfactory adhesive performance results. Examples 21 and 32, which use rubber from examples 10a and 10b, respectively, appear to have particularly good results. Example 21 leaves only a slight residue, while example 32 leaves no residue. The time to peel appears satisfactory for each of examples 21 and 32. Example 21 has a peel strength result of 908, while example 32 has a result of 1163, each of which is comparable to the results for comparative examples 34 and 35, which have results of 1500 and 787, respectively. Example 21 has a tack result of 345, while example 32 has a result of 1160, each of which is comparable to the results for comparative examples 34 and 35, which have results of 705 and 940, respectively. Example 21 has a shear result of 2782, while example 32 has a result of 1159, each of which is comparable to the results for comparative examples 34 and 35, which have results of 2500 and 1654, respectively. Example 21 was made from the rubber of example 10a, which was fully soluble in acetone, as indicated in Table 3, where the gel content for example 10a in acetone was less than 1%. Example 32 was made from the rubber of example 10b, which was nearly fully soluble in acetone, as indicated in Table 3, where the gel content for example 10b in acetone was 7%. The rubber in examples 10a and 10b contained 62 phr butadiene, 13 phr styrene, 16 phr acrylonitrile and 9 phr methacrylic acid.

It is believed that at least all of the monomer ratios set forth in Table 2 provide satisfactory adhesive performance results. Therefore, it is believed that a random copolymer formed by emulsion polymerization containing from about 59 to about 77 phr butadiene, from about 10 to about 16 phr styrene, from about 10 to about 16 phr acrylonitrile and from about 3 to about 9 phr methacrylic acid monomer formulated into a pressure-sensitive adhesive composition using acetone as a solvent will provide satisfactory adhesive performance results, making the use of the pressure-sensitive adhesive composition exempt from regulation of emissions of volatile organic compounds since acetone is exempt from such regulation in the U.S. by the U.S. EPA. In particular, it is believed that a random copolymer formed by emulsion polymerization of 68 phr butadiene monomer, 13 phr styrene monomer, 13 phr acrylonitrile monomer and 6 phr methacrylic acid monomer, which is formulated into a pressure-sensitive adhesive composition using acetone as a solvent, will provide satisfactory adhesive performance results,

### Examples 36-37

### Pressure-Sensitive Adhesive Composite and its Use in Shoe Industry

For examples 36 and 37 of this invention, a pressure-sensitive adhesive (PSA) was prepared using the rubber of example 1a and the formulation shown in Table 7. For comparison purposes, another PSA was prepared using Solprene 1205, which is a commercially-available rubber used typically to prepare PSA (Table 8). Each of the examples 36 and 37 was prepared by dissolving the components described in Tables 7 and 8 using a high shear agitator, first starting to dissolve the rubber in acetone for our invention and toluene for Solprene 1205, and then pouring in subsequently other components until complete dissolution of all components was obtained. Preparation flasks were weighed before and after the dissolution of the components in order to replace losses of solvent.

As a commercial reference, an adhesive based in polyisoprene and toluene, which is sold by Corporation Tadzai S.A. de C.V. under the trademark Lider'z Voch-30, and typically used in the shoe industry was also tested.

TABLE 7
Formulation of PSA Composite
for Examples 36.

| Raw Material | phr |
|---|---|
| Rubber from Example 1a | 100 |
| of this patent | |
| Resin Sylvares TP-7042 | 75 |
| Dioctyl phthalate, | 15 |
| Alcanox P-24 | 2.5 |
| Ethyl zimate | 2.0 |
| Sulfur | 2.0 |
| Zinc oxide | 2.0 |
| Acetone | 750 |

TABLE 8
Formulation of PSA Composite for Examples 37.

| Raw Material | phr |
|---|---|
| Solprene 1205 | 100 |
| Resin Silvares TP-7042 | 75 |
| Stearic acid | 1.0 |
| Sulfur | 2.0 |
| Dioctyl phthalate, | 15.0 |
| Zinc oxide | 2.0 |
| Alcanox P-24 | 2.5 |
| Toluene | 750 |

A standard test method (NMX-K-515-1981) was used to evaluate the performance of the PSAs. In this test, a couple of standard fabric pieces (No. 20) are glued with each PSA composition using a hot press at 20 kg/cm2 for 30 min. After that, the glued fabric pieces are detached from one another using the Universal Tensiometer machine in order to measure maximum stress during the detachment process.

Results of maximum stress for each PSA are shown in Table 9:

TABLE 9
Adhesive performance results.

| | Maximum Stress |
|---|---|
| Adhesive made of: | Kg/cm |
| Example 36 (our copolymer) | 5.56 |
| Example 37 (made of | 2.01 |
| Solprene 1205) | |
| Commercial adhesive Lider'z | 5.50 |
| Voch-30 | |

The PSA in example 36, which is the formulation in example 36 (Table 7) that uses our rubber composition in example 1 and acetone as a solvent, had the highest maximum stress value of 5.56 kg/cm. The PSA of the present invention compares very favorably to the example 37 PSA formulated in Table 8 using Solprene 1205 with toluene as a solvent and is comparable to the 5.50 kg/cm maximum stress value measured for Lider'z Voch-30 adhesive. These results show that a copolymer prepared with the monomer ratios set forth for example 1 in Table 2 provides satisfactory adhesive performance results. It is believed that the similar compositions set forth as examples 2-11 in Table 2 will also perform satisfactorily in an adhesive composition. Therefore, it is believed that a random copolymer formed by emulsion polymerization containing from about 59 to about 77 phr butadiene, from about 10 to about 16 phr styrene, from about 10 to about 16 phr acrylonitrile and from about 3 to about 9 phr methacrylic acid monomer formulated into a pressure-sensitive adhesive composition prepared in acetone as a solvent will provide satisfactory adhesive performance results as good as commercial adhesives and with the advantage that our rubber is soluble in acetone which is a solvent exempt from such regulation in the U.S. by the U.S. EPA.

### EMBODIMENTS OF THE INVENTION

Various embodiments of the present invention are identified as follows.

The present invention provides a polymer composition, comprising: (a) from 30 to 80 phr butadiene, (b) from 5 to 30 phr styrene; (c) from 5 to 30 phr acrylonitrile; and (d) from 1 to 20 phr methacrylic acid. The polymer composition is preferably soluble in acetone to the extent of having a gel content in acetone of less than about 10 wt %, and the polymer composition is preferably also soluble in toluene to the extent of having a gel content in toluene of less than about 60 wt %.

The present invention provides a polymer composition, comprising: (a) from 50 to 80 phr butadiene, (b) from 10 to 20 phr styrene; (c) from 10 to 20 phr acrylonitrile; and (d) from 3 to 12 phr methacrylic acid, where the polymer composition is preferably soluble in acetone to the extent of having a gel content in acetone of less than or equal to about 7 wt %.

The present invention provides a polymer composition, comprising: (a) from 59 to 77 phr butadiene, (b) from 10 to 16 phr styrene; (c) from 10 to 16 phr acrylonitrile; and (d) from 3 to 9 phr methacrylic acid, where the polymer composition is preferably soluble in acetone to the extent of having a gel content in acetone of less than or equal to about 5 wt %. In another embodiment, this polymer composition is soluble in toluene to the extent of having a gel content in toluene of less than about 40 wt %. The polymer is preferably made via an emulsion process using free radical polymerization, where the resulting polymer composition is an amorphous, random copolymer. Calcium chloride is a suitable coagulating agent in an emulsion polymerization process. If calcium chloride is used as the coagulating agent, the calcium becomes part of the polymer composition in which case a measurable amount of calcium can be found in the polymer composition, indicating that calcium chloride was used as a coagulating agent in an emulsion polymerization process. The measurable amount of calcium is less than about 0.1 wt %, but greater than the amount of calcium measured in a similar polymer composition made using a non-calcium coagulant.

The weight-average molecular weight (MWw) of the several polymer compositions described above is typically between about 100,000 and about 2,000,000, preferably between about 95,000 and about 210,000, and more preferably between about 135,000 and about 185,000. The Mooney viscosity [ML1+4 (100° C.)] of the several polymer compositions ranges preferably from about 15 to 150, more preferably from about 15 to 45. The glass transition temperature of the several polymer compositions ranges preferably from about −50° C. to about 0° C., more preferably from about −45° C. to about −15° C. In one embodiment of the invention for the polymer composition with 59 to 77 phr butadiene, the MWw of the polymer composition is between about 90,000 and about 200,000 and has a glass transition temperature of from about −50° C. to about −10° C. and a Mooney viscosity [ML1+4 (100° C.)] of from about 10 to 50, and preferably the gel content in acetone of not more than about 10% by weight.

A polymer composition comprising a random copolymer of about 68 phr butadiene monomer, about 13 phr styrene monomer, about 13 phr acrylonitrile monomer and about 6 phr methacrylic acid monomer, wherein the polymer composition is soluble in acetone to the extent of having a gel content in acetone of less than or equal to about 1 wt % is one embodiment of the invention. Another embodiment of the invention comprises from 59 to 71 phr butadiene, from 10 to 16 phr styrene; from 13 to 16 phr acrylonitrile; and from 3 to 9 phr methacrylic acid.

Another embodiment of the invention further comprises a tackifying resin, a plasticizer oil, sulfur, zinc oxide, an anti-oxidative agent and a U.S. EPA-exempt solvent, which forms a pressure sensitive adhesive composition. The pressure sensitive adhesive composition preferably comprises about 100 parts by weight of the polymer composition, at least about 130 parts by weight of the tackifying resin, at least about 47 parts by weight of the plasticizer oil, at least about 3 parts by weight of sulfur, at least about 3 parts by weight of zinc oxide, at least about 6 parts by weight of the anti-oxidative agent, and at least 300 parts by weight of the U.S. EPA-exempt solvent, preferably acetone. The polymer composition is preferably a random copolymer having a MWw of between about 80,000 and about 300,000, where the polymer composition preferably has a gel content in acetone of not more than about 10% by weight. The composition includes at least 750 parts by weight of acetone in one embodiment.

One embodiment of the invention is a composition of matter comprising a copolymer of butadiene, styrene, acrylonitrile and methacrylic acid, where the composition of matter is soluble in acetone to the extent of having a gel content in acetone of less than about 5 wt %, where the composition of matter is soluble in toluene to the extent of having a gel content in toluene of less than about 30 wt %, where the composition of matter has a MWw of between about 90,000 and about 250,000, and wherein the composition of matter comprises: from 59 to 71 phr butadiene, from 10 to 16 phr styrene; from 13 to 16 phr acrylonitrile; and from 3 to 9 phr methacrylic acid. Another embodiment of the invention is a polymer composition comprising a random copolymer of about 68 phr butadiene monomer, about 13 phr styrene monomer, about 13 phr acrylonitrile monomer and about 6 phr methacrylic acid monomer, wherein the polymer composition is soluble in acetone to the extent of having a gel content in acetone of less than or equal to about 1 wt %.

The invention further provides a process for making a copolymer, comprising the steps of: feeding butadiene, styrene, acrylonitrile and methacrylic acid monomers to a reactor; adding a free radical initiator to the reactor; copolymerizing the butadiene, styrene, acrylonitrile and methacrylic acid monomers until a conversion of from about 75% to about 95% is reached; and recovering a butadiene-styrene-acrylonitrile-methacrylic acid (BSAMAA) copolymer having a composition of from 59 to 77 phr butadiene, from 10 to 16 phr styrene; from 10 to 16 phr acrylonitrile; and from 3 to 9 phr methacrylic acid. The MWw of the BSAMAA copolymer is preferably between about 80,000 and about 250,000. The free radical initiator is preferably an organic hydroperoxide, an inorganic peroxide and/or an azoisobutylonitrile-type of free radical initiator, and potassium persulfate is suitable. The process is preferably an emulsion polymerization in an aqueous medium for copolymerizing the butadiene, styrene, acrylonitrile and methacrylic acid monomers. For an emulsion polymerization, a coagulating agent is added to the reactor to coagulate the copolymer. The coagulating agent can be one or more of aluminum chloride, calcium chloride, iron chloride, magnesium chloride, potassium chloride, sodium chloride, cobalt nitrate, aluminum sulfate, iron sulfate, magnesium sulfate, nickel sulfate, zinc sulfate, hydrochloric acid, nitiric acid, sulfuric acid and a solution of sodium chloride in a sulfuric acid solution, while calcium chloride was used as an example. The BSAMAA copolymer preferably has a gel content in acetone of not more than about 1, 2, 3, 4, 5, 6, 7, 8, 9, 10, 11, 12 or 13% by weight. The BSAMAA copolymer preferably has a gel content in toluene of not more than about 1, 5, 10, 15, 20, 25, 30, 35, 40, 45 or 50% by weight. In one embodiment, the BSAMAA copolymer has a gel content in acetone of not more than about 7% by weight, where the MWw of the BSAMAA copolymer is between about 90,000 and about 200,000 and has a glass transition temperature of from about −50° C. to about −10° C. and a Mooney viscosity [ML1+4 (100° C.)] of from about 10 to 50.

The present invention further provides an article of manufacture comprising an adhesive adhered to an item, wherein the adhesive comprises: about 100 parts by weight of a polymer composition; at least about 130 parts by weight of a tackifying resin; at least about 47 parts by weight of a plasticizer oil; at least about 3 parts by weight of sulfur; at least about 3 parts by weight of zinc oxide: at least about 6 parts by weight of an anti-oxidative agent; and at least 300 parts by weight of an U.S. EPA-exempt solvent, preferably acetone, and where the polymer composition comprises: from 59 to 77 phr butadiene, from 10 to 16 phr styrene; from 10 to 16 phr acrylonitrile; and from 3 to 9 phr methacrylic acid. The item is preferably a backing material, making the article of manufacture a tape. The backing material may be a styrene-butadiene rubber saturated crepe paper. In another application, the item is a part of a shoe. The polymer composition is preferably a random copolymer having a MWw of between about 90,000 and about 250,000, where the polymer composition has a gel content in acetone of not more than about 8% by weight.

The above detailed description of the present invention is given for explanatory purposes. It will be apparent to those skilled in the art that numerous changes and modifications can be made without departing from the scope of the invention. Accordingly, the whole of the foregoing description is to be construed in an illustrative and not a limitative sense, the scope of the invention being defined solely by the appended claims.

What is claimed is:

1. A polymer composition, comprising:
(a) from 59 to 77 phr butadiene,
(b) from 10 to 16 phr styrene;
(c) from 10 to 16 phr acrylonitrile; and
(d) from 3 to 9 phr methacrylic acid.

2. The polymer composition of claim 1, wherein the polymer composition is soluble in acetone to the extent of having a gel content in acetone of less than or equal to about 7 wt %.

3. The polymer composition of claim 1, wherein the polymer composition is soluble in acetone to the extent of having a gel content in acetone of less than or equal to about 5 wt % and wherein the polymer composition is soluble in toluene to the extent of having a gel content in toluene of less than about 40 wt %.

4. The polymer composition of claim 3, wherein the polymer composition is amorphous.

5. The polymer composition of claim 1, wherein the polymer composition is soluble in acetone to the extent of having a gel content in acetone of less than or equal to about 7 wt %, and wherein the polymer composition has a weight-average molecular weight (MWw) of between about 100,000 and about 2,000,000.

6. The polymer composition of claim 5, wherein the MWw of the polymer composition between about 95,000 and about 210,000.

7. The polymer composition of claim 6, wherein the MWw of the polymer composition between about 135,000 and about 185,000.

8. The polymer composition of claim 1, wherein the polymer composition is soluble in acetone to the extent of having a gel content in acetone of less than or equal to about 7 wt %, and wherein the polymer composition contains an amount of calcium that is indicative of calcium chloride being used as a coagulating agent in an emulsion polymerization process.

9. The polymer composition of claim 1, wherein the polymer composition has a gel content in acetone of not more than about 10% by weight and a Mooney viscosity [ML1+4 (100° C.)] of from about 15 to 150.

10. The polymer composition of claim 1, wherein the polymer composition has a Mooney viscosity [ML1+4 (100° C.)] of from about 15 to 45.

11. The polymer composition of claim 1, wherein the polymer composition has a glass transition temperature of from about −50° C. to about 0° C.

12. The polymer composition of claim 1, wherein the polymer composition has a glass transition temperature of from about −45° C. to about −15° C.

13. The polymer composition of claim 1, wherein the MWw of the polymer composition is between about 90,000 and about 200,000 and has a glass transition temperature of from about −50° C. to about −10° C. and a Mooney viscosity [ML1+4 (100° C.)] of from about 10 to 50.

14. The polymer composition of claim 13, wherein the polymer composition has a gel content in acetone of not more than about 10% by weight.

15. The polymer composition of claim 1, further comprising a tackifying resin, a plasticizer oil, sulfur, zinc oxide, an anti-oxidative agent and a U.S. EPA-exempt solvent, thereby forming a pressure sensitive adhesive composition, wherein the pressure sensitive adhesive composition comprises
a. about 100 parts by weight of the polymer composition;
b. at least about 130 parts by weight of the tackifying resin;
c. at least about 47 parts by weight of the plasticizer oil;
d. at least about 3 parts by weight of sulfur;
e. at least about 3 parts by weight of zinc oxide:
f. at least about 6 parts by weight of the anti-oxidative agent; and
g. at least 300 parts by weight of the U.S. EPA-exempt solvent.

16. The polymer composition of claim 15, wherein the polymer composition is a random copolymer having a MWw of between about 80,000 and about 300,000, wherein the polymer composition has a gel content in acetone of not more than about 10% by weight, and wherein the U.S. EPA-exempt solvent is acetone.

17. The polymer composition of claim 16, wherein the pressure sensitive adhesive composition includes at least 750 parts by weight of acetone.

18. A composition of matter comprising a copolymer of butadiene, styrene, acrylonitrile and methacrylic acid, wherein the composition of matter is soluble in acetone to the extent of having a gel content in acetone of less than about 5 wt %, wherein the composition of matter is soluble in toluene to the extent of having a gel content in toluene of less than about 30 wt %, wherein the composition of matter has a MWw of between about 90,000 and about 250,000, and wherein the composition of matter comprises:
from 59 to 71 phr butadiene,
from 10 to 16 phr styrene;
from 13 to 16 phr acrylonitrile; and
from 3 to 9 phr methacrylic acid.

19. A polymer composition comprising a random copolymer of about 68 phr butadiene monomer, about 13 phr styrene monomer, about 13 phr acrylonitrile monomer and about 6 phr methacrylic acid monomer, wherein the polymer composition is soluble in acetone to the extent of having a gel content in acetone of less than or equal to about 1 wt %.

20. The polymer composition of claim 19, wherein the polymer composition is soluble in toluene to the extent of having a gel content in toluene of less than or equal to about 1 wt %.
